(19) United States
(12) Patent Application Publication
(10) Pub. No.: US 2009/0047191 A1
(43) Pub. Date: Feb. 19, 2009

(54) CLOSED SPACE DISPOSABLE MICRO-REACTOR AND USES THEREOF

(76) Inventors: Gafur Zainiev, West Bloomfield, MI (US); Inlik Zainiev, West Bloomfield, MI (US)

Correspondence Address: GIFFORD, KRASS, SPRINKLE,ANDERSON & CITKOWSKI, P.C, PO BOX 7021, TROY, MI, 48007-7021, US

(21) Appl. No.: 12/135,597

(22) Filed: Jun. 9, 2008

Related U.S. Application Data
(60) Provisional application No. 60/942,939, filed on Jun. 8, 2007.

(51) Int. Cl. B01J 19/00

(52) U.S. Cl. 422/198; 422/129

(57) ABSTRACT

A closed space disposable micro-reactor is provided with a capillary vessel with a first end and a second end, a first closed air chamber wherein said first end of the capillary vessel opens into the first closed air chamber; and a second closed air chamber wherein the second end of the capillary chamber opens into said second closed air chamber. The capillary vessel is pre-filled with a liquid sample. A droplet of reagent set in proximity to the first end of the capillary vessel is provided. Also provided is a partner capillary vessel with a first partner end and a second partner end, and a third closed air chamber wherein the first partner end of the partner capillary vessel opens into the second closed air chamber, and the second partner end opens to the second air chamber.

### CROSS REFERENCE TO RELATED APPLICATIONS

This application claims priority from U.S. Provisional Application Ser. No. 60/942,939 filed on Jun. 8, 2007, the entire contents of which are incorporated herein by reference.

### FIELD OF THE INVENTION

The present invention relates in general to a microreactor for chemical reaction control and detection of participating reactants and resultant products and in particular to closed space disposable micro-reactor for gene expression diagnostics.

### BACKGROUND OF THE INVENTION

Micro-fabrication technologies are now well known and include sputtering, electrode position, low-pressure vapor deposition, photolithography, and etching. These and similar processes are applied to the fabrication of reaction chambers and their control elements such as heaters, thermo-couplers, detectors, sensors, electrodes, and other devices that are used to sense and control the reaction parameters.

In the field of genetic quantification, the commercially available gene chips enable simultaneous mass detection of gene expression. However, the sophisticated photolithographic technology needed to design and build the chips is expensive and time consuming. In addition, required instrumentation system which often includes a fluidics station, a multi-reading scanner, and a chip workstation exceeds the resources of many research entities.

Thus there exists a need for a cost-effective and customizable apparatus to facilitate content mixing, fusion, and separation in the context of identifying and detecting expression of a gene, in particular the copy number variation (CNV) of that gene.

### SUMMARY OF THE INVENTION

A closed space disposable micro-reactor is provided with a capillary vessel with a first end and a second end, a first closed air chamber wherein said first end of the capillary vessel opens into the first closed air chamber; and a second closed air chamber wherein the second end of the capillary chamber opens into said second closed air chamber. The capillary vessel is pre-filled with a liquid sample that moves by a pressure difference between first air pressure within the first closed air chamber and second air pressure within the second closed air chamber. The pressure difference is caused by a differential heating to the first air chamber and the second air chamber.

A droplet of reagent set in proximity to the first end of the capillary vessel is provided.

Also provided is a partner capillary vessel with a first partner end and a second partner end, and a third closed air chamber wherein the first partner end of the partner capillary vessel opens into the second closed air chamber, and the second partner end opens to the second air chamber.

An inventive closed space disposable micro-reactor also has the capillary vessel and the partner capillary vessel aligned side-by-side with the second end of the capillary vessel and the second partner end of the partner capillary vessel aligned flush.

The capillary vessel and the partner capillary vessel are vertically aligned so that the second end of the capillary vessel is in direct opposition with a gap to the first partner end of the partner capillary vessel.

A closed space disposable micro-reactor is also provided with one or more capillary vessels having a first end and a second end, a first closeable air chamber into which the first end of the capillary vessel opens into the first closable air chamber, and a second closeable air chamber wherein the second end of the capillary vessel opens into, and the capillary vessel is pre-filled with a sample.

The inventive closed space disposable micro-reactor also has a film inside each of the closeable air chambers capable of supporting a drop in a fixed position within the first closeable air chamber, and a film inside said second closeable air chamber capable of supporting a drop in a fixed position within said first closeable air chamber.

### BRIEF DESCRIPTION OF THE DRAWINGS

FIGS. 1A-1D are schematics depicting various stages of content movement of type 1 closed space disposable (CSD) micro-reactor in accordance with the present invention.

FIGS. 2A-2D are schematics depicting various stages of content movement of type 2 closed space disposable (CSD) micro-reactor in accordance with the present invention.

FIGS. 3A-3E are schematics depicting various stages of content movement of type 3 closed space disposable (CSD) micro-reactor in accordance with the present invention.

FIGS. 4A-4E are schematics depicting various stages of content movement of type 4 closed space disposable (CSD) micro-reactor in accordance with the present invention.

FIGS. 5A-5D are schematics depicting various stages of content movement of type 5 closed space disposable (CSD) micro-reactor in accordance with the present invention.

FIGS. 6A-6F are schematics depicting various stages of content movement of type 6 closed space disposable (CSD) micro-reactor in accordance with the present invention.

FIGS. 7A-7E are schematics depicting various stages of content movement of type 7 closed space disposable (CSD) micro-reactor in accordance with the present invention.

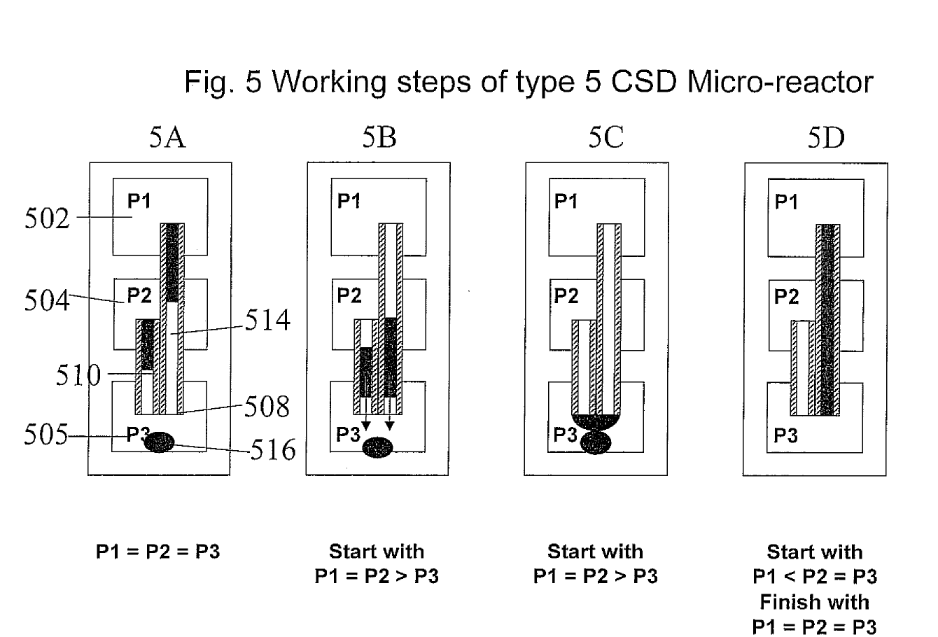

FIGS. 5A-5B are schematics depicting an exemplary layout of macro-array of type 1 CSD micro-reactors and an exemplary layout of macro-array of type 2 CSD micro-reactors.

FIGS. 9A-9C are schematics depicting an exemplary layout of micro-reactors in vertical alignment in accordance with the present invention.

FIGS. 10A-10C are schematics depicting various stages of content movement and incubation to provide detection and identification of CNVs of one or more target strands.

### DESCRIPTION OF THE PREFERRED EMBODIMENTS

The present invention has utility as an apparatus and a process thereof to maximize content mixing, fusion, and transfer amongst thin capillary vessels.

A CSD micro-reactor contains capillary channels with both ends inserted within a closed space such as a closed air chamber. CSD micro-reactors have variable lengths and are arrayed in alternative ways such as side-by-side, head-to-toe, or any other ways an end user finds fit for a specific application. Particular contents, mostly in liquids, are pre-filled within the capillary channels of the CSD micro-reactors. This is typically done during the manufacture of the CSD micro-reactors, yet can occur at the time of use. At least one of the channels is to be filled by an end-user with a material under investigation. The closed space design of the CSD micro-reactors eliminates or reduces unnecessary contamination by foreign substances. The CSD micro-reactors are made of light-weight, transparent materials, such as plastics, glass, or synthetic films.

A basic inventive unit composed of one CSD micro-reactor has both ends each inserted into a closed air chamber. External forces such as heating, cooling, or pressurization are applied to one or both the closed air chambers so as to induce a pressure change in the air within the closed air chamber. Differential heating treatment to the two closed air chambers causes the movement of the content within the capillary channel of the CSD micro-reactor.

An inventive unit of two CSD micro-reactors arranged side-by-side, butt-ends of the capillary channels of both the CSD micro-reactors are positioned in a way that allows mixing of contents forced out of the channels such that there is no horizontal escape of the contents beyond the circumventing edges of the butt-ends.

Optionally, all the capillary channels of an inventive CSD micro-reactor are positioned in a way that allows light beam to go through in a consecutive order. This allows continuous detection of the contents and the mixing thereof.

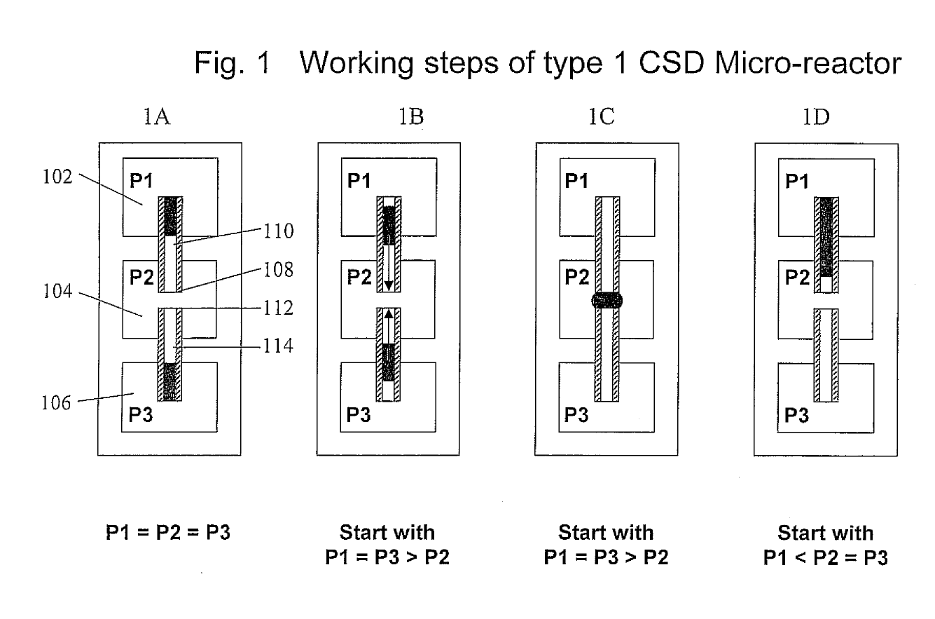

FIGS. 1A-1D are schematics depicting various stages of content movement of in an inventive closed space disposable (CSD) micro-reactor. P1, P2, P3 represent air pressures within closed air chamber one 102, closed air chamber two 104, and closed air chamber three 106, respectively. Two CSD micro-reactors, a top CSD micro-reactor 110 and a bottom CSD micro-reactor 114, are each separately positioned between two of the three closed air chambers (closed air chamber one 102, closed air chamber two 104, and closed air chamber three 106). The CSD micro-reactors are thin capillary vessels in nature and are open at both ends to respective air chambers. Particular contents, preferably suspended or dissolved in movable liquids, are introduced to the CSD micro-reactors by manufacture (FIG. 1A). When air pressure is manipulated such that P1=P3>P2 by external forces such as heating, pressure within chamber one 102 and chamber three 106 increases and the contents get pushed towards air chamber two 104 where air pressure is lower (FIG. 1B). Continued pressure differential maintenance causes the contents to exit both the CSD micro-reactors 110 and 114 and merge in between to form a combined mixture (FIG. 1C). An air space is created between the bottom end 108 of the top CSD micro-reactor 110 and the top end 112 of the bottom CSD micro-reactor 114 such that no horizontal movement of the contents is allowed to occur outside the circumvented edges of the CSD micro-reactors. Alternatively, when air pressure is changed through external forces such that P1<P2=P3, all contents are pushed upward to the air chamber 1 (FIG. 1D).

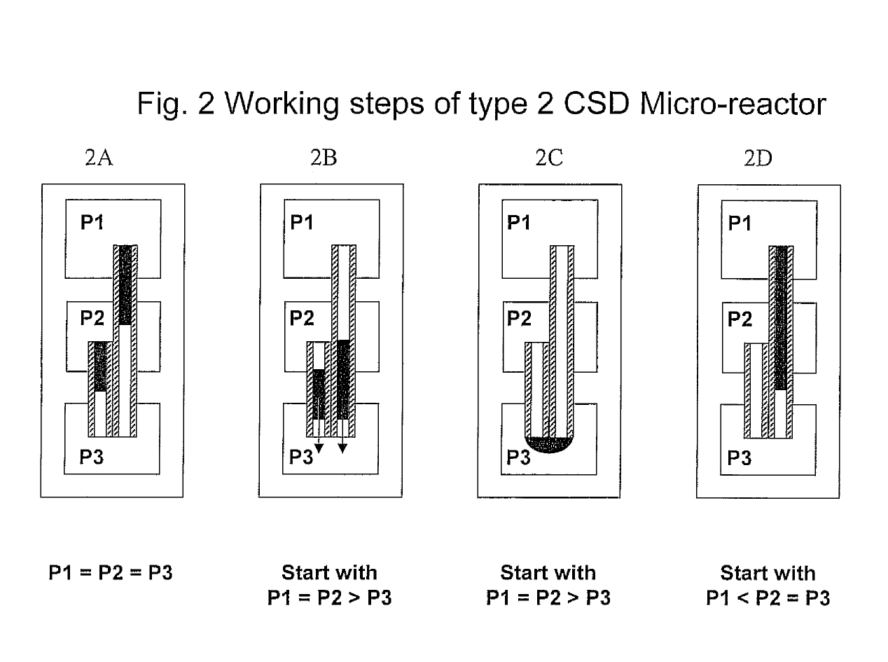

FIGS. 2A-2D are schematics depicting various stages of content movement in another type of inventive closed space disposable (CSD) micro-reactor. P1, P2, and P3 each represents air pressure within one of three closed air chambers shown un-shaded (chamber one 202, chamber two 204, and chamber three 206). Two CSD micro-reactors in different lengths (shorter vessel 210 and longer vessel 214) are placed side-by-side and each positioned between two of the three closed air chambers. The CSD micro-reactors are thin capillary vessels in nature and are open at both ends to respective air chambers. Particular contents, preferably suspended or dissolved in movable liquids, are introduced to the CSD micro-reactors by manufacture (FIG. 2A). When air pressure is manipulated such that P1=P2>P3 by external forces such as heating, air expands within chamber one 202 and chamber two 204 and the contents are pushed towards air chamber three 206 where air pressure is lower (FIG. 2B). Further application of pressure causes the contents to exit outside both the CSD micro-reactors and merge at the bottom ends 208 of both the CSD micro-reactors to form a combined mixture (FIG. 2C). The width of the CSD micro-reactors are so designed that no horizontal movement of the combined contents is allowed to occur outside the circumvented edges of the CSD micro-reactors. Alternatively, when air pressure is changed through external forces such that P1<P2=P3, all contents are pushed upward to air chamber one 202 (FIG. 2D).

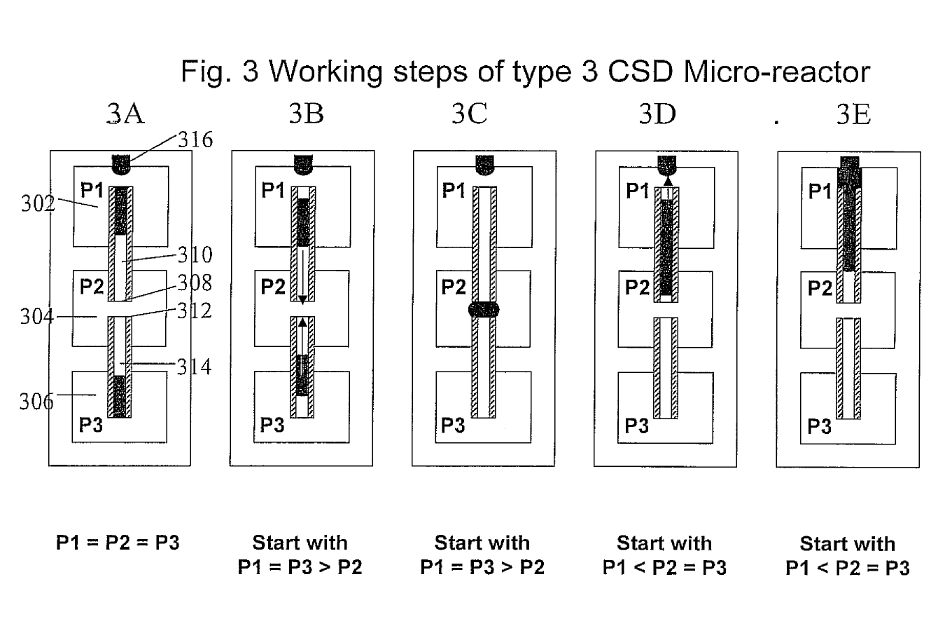

FIGS. 3A-3E are schematics depicting various stages of content movement in another configuration of inventive closed space disposable (CSD) micro-reactor in accordance with the present invention. P1, P2, and P3 each represents air pressure within one of three closed air chambers shown un-shaded (chamber one 302, chamber two 304, and chamber three 306). Two CSD micro-reactors (a top CSD micro-reactor 310, and bottom CSD micro-reactor 314) are each separately positioned between two of the three closed air chambers. The CSD micro-reactors are thin capillary vessels in nature and are open at both ends to respective air chambers. Particular contents, preferably suspended or dissolved in movable liquids, are introduced to the CSD micro-reactors by manufacture (FIG. 3A). When air pressure is manipulated such that P1=P3>P2 by external forces such as heating, air expands within chamber one 302 and chamber three 306 and the contents are pushed towards air chamber two 304 where air pressure is lower (FIG. 3B). Further application of pressure causes of the contents to exit outside both the CSD micro-reactors and merge in between to form a combined mixture (FIG. 3C). An air space is created between the bottom end 308 of the top CSD micro-reactor 310 and the top end 312 of the bottom CSD micro-reactor 314 such that no horizontal movement of the contents is allowed to occur outside the circumvented edges of the CSD micro-reactors. Alternatively, when air pressure is changed through external forces such that P1<P2=P3, all contents are pushed upward to the air chamber one 302 (FIG. 3D). Additionally, a dose of a particular reagent such as a droplet of DNA stain solution is placed on top end 316 of air chamber one 302. Therefore, the combined contents optionally merge with the droplet of DNA stain solution to provide a way of visualization of content movement (FIG. 3E).

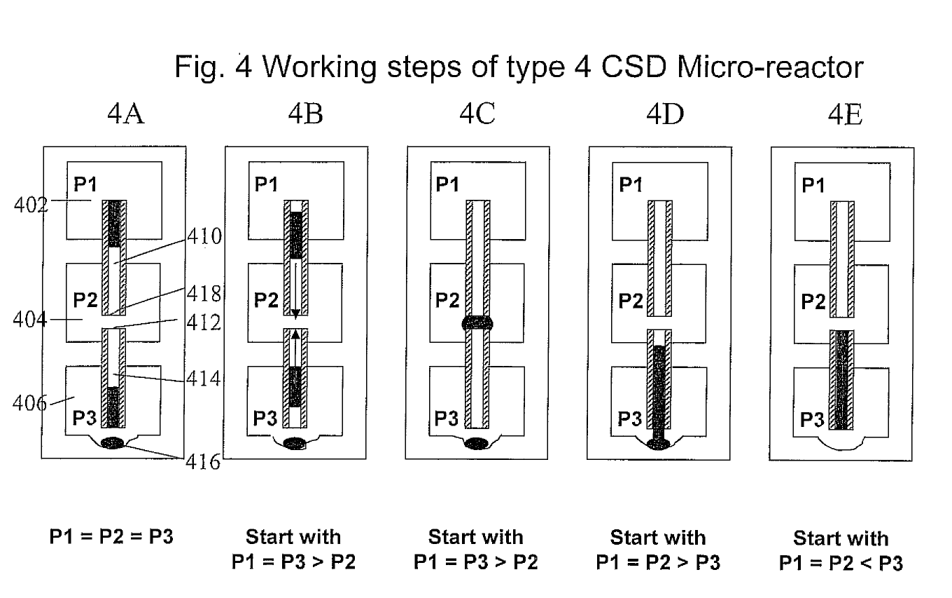

FIGS. 4A-4E are schematics depicting various stages of content movement in another configuration of inventive closed space disposable (CSD) micro-reactor in accordance with the present invention. P1, P2, and P3 each represents air pressure within one of three closed air chambers shown un-shaded (chamber one 402, chamber two 404, and chamber three 406). Two CSD micro-reactors (a top CSD micro-reactor 410 and a bottom CSD micro-reactor 414) are each separately positioned between two of the three closed air chambers. The CSD micro-reactors are thin capillary vessels in nature and are open at both ends to respective air chambers. Particular contents, preferably suspended or dissolved in movable liquids, are introduced to the CSD micro-reactors by manufacture (FIG. 4A). When air pressure is manipulated such that P1=P3>P2 by external forces such as heating, air expands within chamber one 402 and chamber three 406 and the contents are pushed towards air chamber two 404 where air pressure is lower (FIG. 4B). Further application of pressure causes an exist of the contents outside both the CSD micro-reactors and merge in between to form a combined mixture (FIG. 4C). An air space is created between the bottom end 408 of the top CSD micro-reactor 410 and the top end 412 of the bottom CSD micro-reactor 414 such that no horizontal movement of the contents is allowed to occur outside the circumvented edges of the CSD micro-reactors. Alternatively, when air pressure is changed through external forces such that P1=P2>P3, all contents are pushed downward to the air chamber three 406 (FIG. 4D). Additionally, a dose of a particular reagent such as a droplet of DNA stain solution is placed in a recess enclosed within the bottom end 416 of air chamber three 406. Therefore, the combined contents optionally merge with the droplet of DNA stain solution to provide a way of visualization of content movement (FIG. 4E).

FIGS. 5A-5D are schematics depicting various stages of content movement in another configuration of inventive closed space disposable (CSD) micro-reactor. P1, P2, and P3 each represents air pressure within one of three closed air chambers shown un-shaded (chamber one 502, chamber two 504, and chamber three 506). Two CSD micro-reactors in different lengths (shorter CSD micro-reactor 510 and longer CSD micro-reactor 514) are placed side-by-side and each positioned between two of the three closed air chambers. The CSD micro-reactors are thin capillary vessels in nature and are open at both ends to respective air chambers. Particular contents, preferably suspended or dissolved in movable liquids, are introduced to the CSD micro-reactors by manufacture (FIG. 5A). When air pressure is manipulated such that P1=P2>P3 by external forces such as heating, air expands within chamber one 502 and chamber two and the contents are pushed towards air chamber three 506 where air pressure is lower (FIG. 5B). Further application of pressure causes the contents to exit outside both the CSD micro-reactors and merge at the bottom ends 508 of both the CSD micro-reactors to form a combined mixture (FIG. 5C). The width of the CSD micro-reactors are so designed that no horizontal movement of the combined contents is allowed to occur outside the circumvented edges of the CSD micro-reactors. Additionally, a dose of a particular reagent such as a droplet of DNA stain solution is placed at the bottom end 516 of air chamber three 506. Therefore, the combined contents merge with the droplet of DNA stain solution to provide a way of visualization of content movement and the resulting entire contents get transferred to the longer CSD micro-reactor due to capillary effect (FIG. 5D).

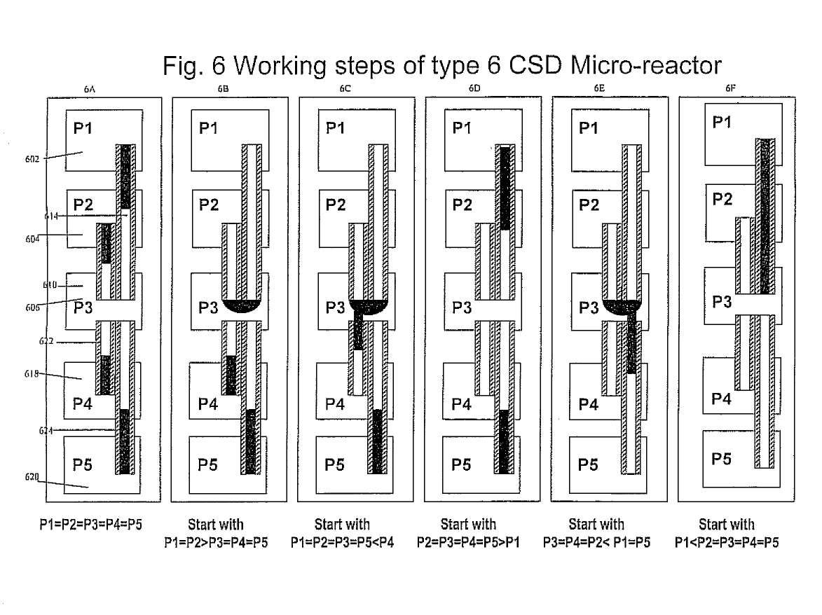

FIGS. 6A-6F are schematics depicting various stages of content movement of in another configuration of inventive closed space disposable (CSD) micro-reactor P1, P2, P3, P4, and P5 each represents an air pressure within one of five closed air chambers shown un-shaded (chamber one 602, chamber two 604, chamber three 606, chamber four 618, and chamber five 620). Top two CSD micro-reactors in different lengths (top short CSD micro-reactor 610 and top long CSD micro-reactor 614) are placed side-by-side and each positioned between two of the three closed air chambers 602, 604 and 606. Similarly, bottom two CSD micro-reactors in different lengths (bottom short CSD micro-reactor 622 and bottom long CSD micro-reactor 624) are placed side-by-side and each positioned between two of the three closed air chambers 606, 618, and 620. The CSD micro-reactors are tin capillary vessels in nature and are open at both ends to respective air chambers. Particular contents, mostly in movable liquids, are introduced to the CSD micro-reactors by manufacture (FIG. 6A). When air pressure is manipulated such that P1=P2>P3=P4=P5 by external forces such as heating, air expands within chamber one 602 and chamber two 604 and the contents within the top two CSD micro-reactors are pushed towards air chamber three 606 where air pressure is lower (FIG. 6B). When air pressure is manipulated such that P1=P2=P3=P5<P4 by external forces such as heating, air within chamber four 618 expands and the content within CSD micro-reactor 618 gets pushed up towards air chamber 606 (FIG. 6C). FIG. 6D illustrates a working step of the CSD micro-reactor when air pressure is manipulated such that P2=P3=P4=P5>P1. FIG. 6E illustrates a working step of the CSD micro-reactor when air pressure is manipulated such that P3=P4=P2<P1=P5. FIG. 6F illustrates a working step of the CSD micro-reactor when air pressure is manipulated such that P1<P2=P3=P4=P5.

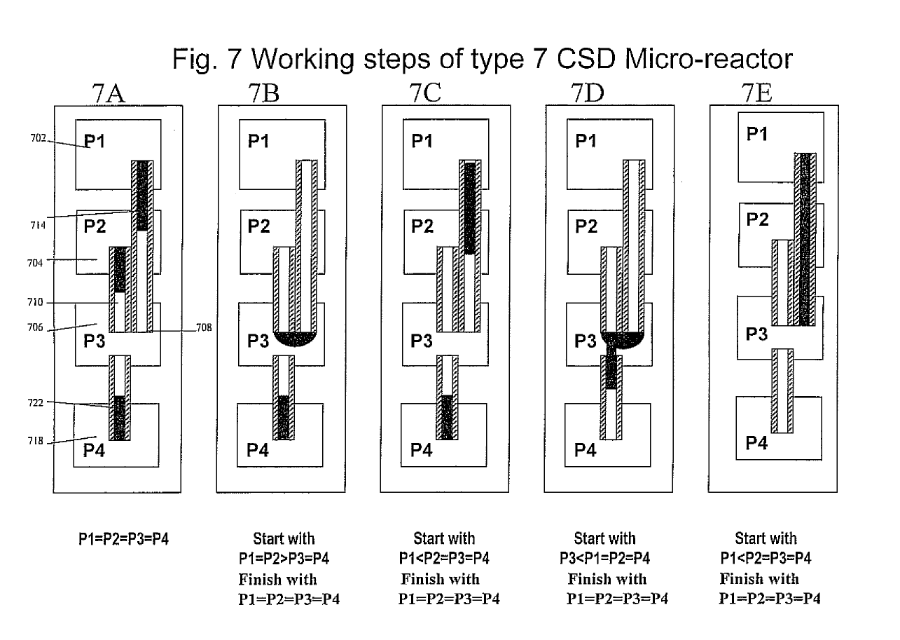

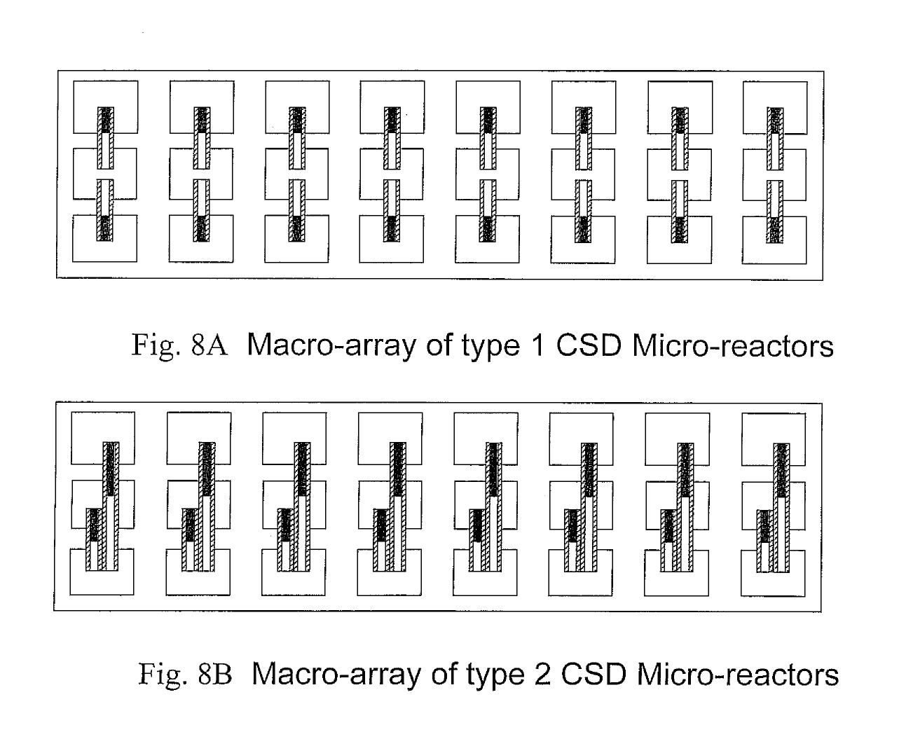

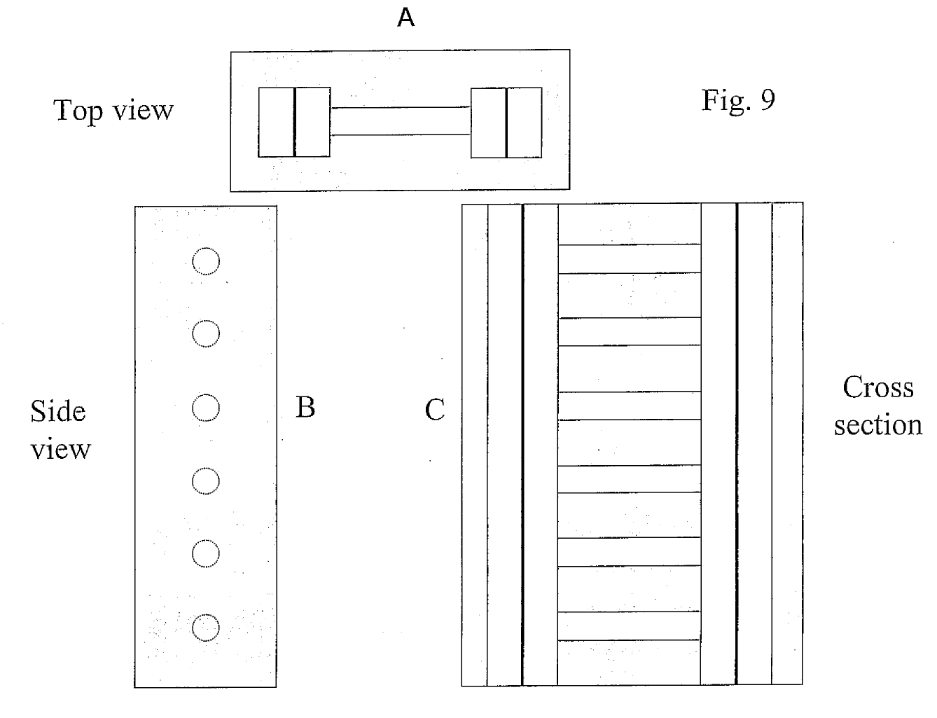

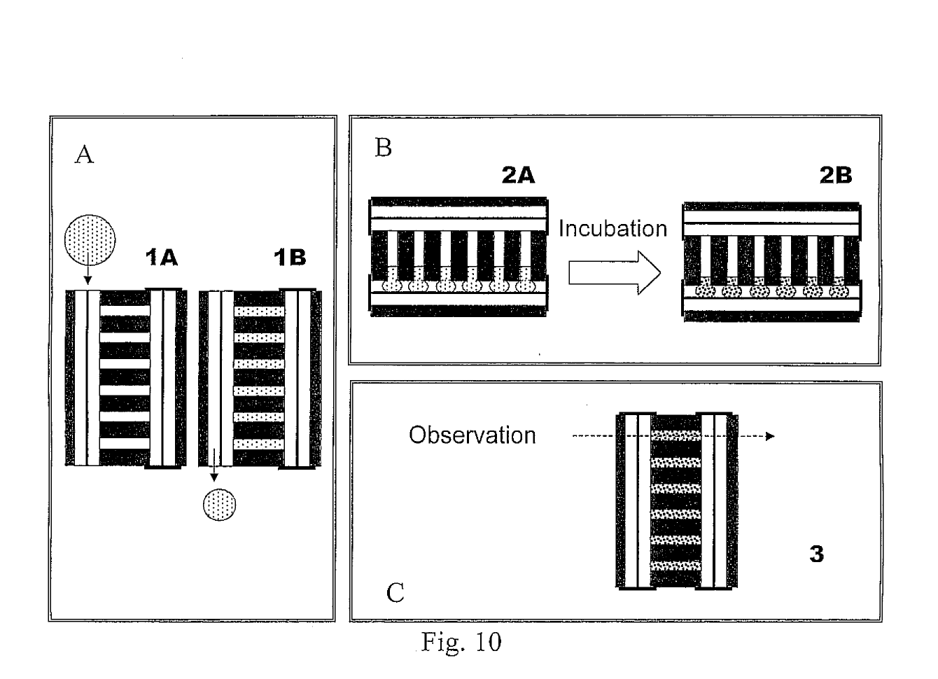

FIGS. 7A-7E are schematics depicting various stages of content movement in another configuration of inventive closed space disposable (CSD) micro-reactor P1, P2, P3, and P4 each represents air pressure within one of four closed air chambers shown un-shaded (chamber one 702, chamber two 704, chamber three 706, and chamber four 718). Two top CSD micro-reactors in different lengths (top short CSD micro-reactor 710 and top long CSD micro-reactor 714) are placed side-by-side and each positioned between two of the three closed air chambers 702, 704, and 706. A single bottom CSD micro-reactor 722 is positioned between two air chambers 706 and 718. The CSD micro-reactors are thin capillary vessels in nature and are open at both ends to respective air chambers. Particular contents, preferably suspended or dissolved in movable liquids, are introduced to the CSD micro-reactors by manufacture (FIG. 7A). When air pressure is manipulated such that P1=P2>P3=P4 by external forces such as heating, air within chamber one 702 and chamber two 704 gets expanded and the contents get pushed towards air chamber three 706 where air pressure is lower (FIG. 7B). Further application of heating causes of the contents to exit outside both the CSD micro-reactors and merge at the bottom ends 708 of both the CSD micro-reactors to form a combined mixture. The width of the CSD micro-reactors are so designed that no horizontal movement of the combined contents is allowed to occur outside the circumvented edges of the CSD micro-reactors. Consequently, when air pressure is changed through external forces such that P1<P2=P3=P4, the combined contents are pushed upward to air chamber one 702 (FIG. 7C). Consequently, when air pressure is changed through external forces such that P3<P2=P1=P4, all contents from both the side-by-side CSD micro-reactors and the single CSD micro-reactor are pushed towards air chamber three 706 (FIG. 7D). Consequently, when air pressure is further changed through external forces such that P1<P2=P3=P4, all contents then get transferred to the top long CSD micro-reactor 714 (FIG. 7E).

FIGS. 8A-8B are schematics depicting an exemplary layout of macro-array of CSD micro-reactors as detailed with respect to FIGS. 1A-1D (type 1) and an exemplary layout of macro-array of CSD micro-reactors as detailed with respect to FIGS. 2A-2D (type 2). Type 1 CSD micro-reactors are laid in parallel side-by-side (FIG. 8A). Optionally, this resulting unit is further connected to one another depending on the size of samples detected. Similarly, type 2 CSD micro-reactors are laid in parallel side-by-side (FIG. 8B). Optionally, this resulting unit is further connected to one another depending on the size of samples detected.

FIGS. 9A-9C are schematics depicting a vertical alignment micro-reactor device in accordance with the present invention. The center of the device (FIGS. 9A and C) has a plurality of one or more thin capillary vessels which are open at both ends. Each end if the capillary vessels are open to a closable air space encompassed by a vertical chamber. Each vertical chamber of the device (FIG. 9C) has an optionally removable top cover and a removable bottom cover that is optionally positioned over the top and bottom ends of the vertical channels to create a closed space illustratively containing air. Each vertical channel encompasses a vertical film or mesh in sufficient proximity to each capillary channel such as to retain a drop of suspension in a fixed position within each capillary channel when the device is rotated 90 degrees and the capillary channels are arranged vertically. The film or mesh is optionally made of steel, aluminum, synthetic fiber, or other non-reactive or optionally reactive material known in the art. Optionally, the film or mesh is made of low-binding regenerated cellulose or other material known in the art of various pore sizes to allow fluids, molecules or cells of desired sizes to pass the membrane while retaining others.

Each of the capillary vessels optionally contains wet or dry reagents such as bead or other support bound or unbound antibodies, antigens, dyes, small molecules, antibiotics, or other desired detection materials. The contents of the plurality of the capillary vessels is optionally identical or different. In a preferred embodiment the contents of each capillary vessel are unique and illustratively influences propagation of bacterial in its own way. It is appreciated that each capillary chamber optionally contains probe-DNA or target-DNA single strands. Optionally, additional reagents such as DNA stains are present in or added to the capillary chambers.

FIG. 9A depicts a top view of an inventive micro-reactor depicting each vertical channel open and a capillary vessel traversing the distance between each vertical channel. It is appreciated that the orientation of the system is similarly operable if the vertical channels are situated in other orientations. The orientation of a film or mesh is depicted from an end as central within each vertical chamber. It is appreciated that the position of the film or mesh is more or less toward the end of the plurality of capillary vessels. In a most preferred embodiment, the film or mesh is close enough to the capillary chamber so as to retain a drop of suspension in a fixed position within the capillary vessels. FIG. 9B depicts a side view of the film or mesh with dotted outlines representing the positions of the capillary vessels.

The present invention is further detailed with respect to the following examples. These examples are not intended to limit the scope of the appended claims.

### EXAMPLE 1

A particular application to the inventive device is illustrated in FIGS. 10A-10C. Various concentrations of an antibiotic or other reagent are loaded in capillary vessels. As depicted in FIG. 10A, one vertical chamber is sealed at both ends and contains air. The air in the chamber is preferably sterile. The other vertical chamber is open at both ends. An abundant amount of bacteria broth is added to the open vertical chamber and allowed to pass through the chamber by gravity or other force. Preferably, the bacteria broth is a low concentration suspension of bacteria.

While the bacteria broth is passing down the vertical chamber portions are entering the open ends of the capillary vessels by capillary action. After the broth is transferred through the vertical chamber the open chamber is sealed at both ends. As depicted in FIG. 10B, the device is then optionally rotated 90 degrees. The broth within the capillary chambers is retained in a fixed position by the film or mesh such that a large portion of the contents of the capillary vessels are exposed to air. Exposure to air is preferable for incubation of the contents of the capillary chambers. The inventive system allows incubation in a closed system with controlled air, or other gas or liquid tightly regulated during the incubation time. Following termination of incubation, the device is optionally rotated into a vertical position and the contents of the capillary vessels are moved back into each vessel by capillary action and held in position. Optical observation of the contents of each capillary chamber is performed. The longer path length of the capillary vessels provides greater sensitivity than through a drop system. The fixed orientation of the capillary vessels further provides highly sensitive optical observation by non-aid eyes or automatic optical device. Numerous detection devices are known in the art and are operable herein.

The foregoing description is illustrative of particular embodiments of the invention, but is not a limitation upon the practice thereof. The following claims, including all equivalents thereof, are intended to define the scope of the invention.

1. A closed space disposable micro-reactor comprising:
a capillary vessel with a first end and a second end;
a first closed air chamber wherein said first end of said capillary vessel opens into said first closed air chamber; and
a second closed air chamber wherein said second end of said capillary chamber opens into said second closed air chamber; wherein said capillary vessel is pre-filled with a liquid sample and wherein said liquid sample moves by a pressure difference between first air pressure within said first closed air chamber and second air pressure within said second closed air chamber.

2. The closed space disposable micro-reactor of claim 1 wherein said pressure difference is caused by a differential heating to said first air chamber and said second air chamber.

3. The closed space disposable micro-reactor of claim 1 further comprising a droplet of reagent set in proximity to said first end of said capillary vessel.

4. A closed space disposable micro-reactor of claim 1 further comprising:
a partner capillary vessel with a first partner end and a second partner end; and
a third closed air chamber wherein said first partner end of said partner capillary vessel opens into said second closed air chamber; wherein second partner end opens to said second air chamber.

5. A closed space disposable micro-reactor of claim 4 wherein said capillary vessel and said partner capillary vessel are aligned side-by-side wherein said second end of said capillary vessel and said second partner end of said partner capillary vessel are aligned flush.

6. A closed space disposable micro-reactor of claim 4 wherein said capillary vessel and said partner capillary vessel are vertically aligned wherein said second end of said capillary vessel is in direct opposition with a gap to said first partner end of said partner capillary vessel.

7. A closed space disposable micro-reactor comprising
one or more capillary vessels with a first end and a second end;
a first closeable air chamber wherein said first end of said capillary vessel opens into said first closable air chamber; and
a second closeable air chamber wherein said second end of said capillary vessel opens into said second closeable air chamber; wherein said capillary vessel is pre-filled with a sample.

8. The closed space disposable micro-reactor of claim 7 farther comprising
a film inside said first closeable air chamber capable of supporting a drop in a fixed position within said first closeable air chamber; and
a film inside said second closeable air chamber capable of supporting a drop in a fixed position within said first closeable air chamber.
